(19) United States
(12) Patent Application Publication
(10) Pub. No.: US 2016/0092820 A1
(43) Pub. Date: Mar. 31, 2016

(54) METHOD AND SYSTEM FOR PROVIDING DATA ANALYTICS RESULTS

(71) Applicants: Alexander Ebel, Monheim am Rhein (DE); Martin Schneider, Munchen (DE); Sonja Zillner, Munchen (DE)

(72) Inventors: Alexander Ebel, Monheim am Rhein (DE); Martin Schneider, Munchen (DE); Sonja Zillner, Munchen (DE)

(21) Appl. No.: 14/864,415

(22) Filed: Sep. 24, 2015

(30) Foreign Application Priority Data
Sep. 25, 2014 (EP) 14186368.8

(51) Int. Cl. G06Q 10/06

(52) U.S. Cl. CPC G06Q 10/06395

(57) ABSTRACT

A system for providing data analytics results for a process performed in an industrial plant includes a knowledge model repository configured to store semantic knowledge models. The system also includes selection unit configured to select at least one analytics application describing semantically at least one process step and at least one parameter required for accomplishing an analytics task. The system includes a processing unit configured to process the selected analytics application and selected instantiated semantic knowledge models to infer at least one storage location of at least one data source of the industrial plant, and an execution engine configured to execute the selected data analytics application using accessed process data provided by the inferred data sources of the industrial plant to generate the data analytics results.

This application claims the benefit of EP 14186368.8, filed on Sep. 25, 2014, which is hereby incorporated by reference in its entirety.

### FIELD

The present embodiments relate to a method and a system for providing data analytics results for a process performed in an industrial plant.

### TECHNICAL BACKGROUND

Industrial production of goods or intermediate products is performed in a manufacturing process based on a sequence of process steps. At each process step, the properties of the respective intermediate product are modified until the product reaches the required characteristic. The nature of such a manufacturing process is often complex and includes a precise process control. This is true for process-oriented industries like the steel industry.

In order to provide a precise control, a continuous observation of main quality factors is performed at each process step of the manufacturing process within the industrial plant. However, due to the complexity of the process steps, errors occur regularly during the production, which leads to losses and therefore higher costs of the respective end product. The reasons for the occurred errors are often related to the concatenation of slight deviations in the production conditions along the whole process chain or are caused by unreliable measurements. The impact of such disturbances on data is often highly non-linear and multivariate (e.g., several factors affect the process at the same time). For this reasons, the disturbances are difficult to detect by human operators or by standard statistical analysis.

Consequently, data analytic approaches have been applied. Data analytics describe the ability to analyze huge amounts of process data in order to extract the dependencies between different variables allowing also the identification of multivariate disturbances. For the application of data analytic techniques, process data being assigned to particular products along all process steps of the process chain is to be available. Therefore, data analytic approaches use the representation of the complete history of the manufactured product. As of today, the data acquisition of the process data is typically done separately for each process step and relies on different measurement intervals and different measurement precision. For example, within a steel plant during a secondary metallurgy process step, the process data, such as chemical analysis of a charge, is measured only once and directly assigned to the respective intermediate product melt. However, within further process steps such as hot rolling, measurements like the rolling thickness are measured continuously, and the values are assigned to a position on the intermediate product hot strip. If one wants to perform a data analytics application that aims to find out how the number of defects on each part of the end product coil of predetermined length such as 100 m relates to the rolling thickness and chemical analysis, all this process data is to be collected and mapped to the target parameter (e.g., the number of defects at each 100 m part of the end product coil). For being able to do so, the different information types, such as piece-based information (e.g., chemical analysis) or the length-based information (e.g., rolling thickness), are to be transferred and are to be, if necessary, aggregated in order to be able to assign the data to the respective target parameter. It is to be incorporated that the products may consist of different parts of intermediate products. For example, a hot strip may be produced based on two different slabs. The product direction may be changed during the production process. Data values and/or data measurements are to be rededicated. The change of product direction may, for example, happen if a coil box is used during the hot rolling process and causes that the start and the end of a hot strip are interchanged.

Any data analytics application is to be informed about such different transformations of the intermediate products in order to provide a correct data basis for the analytical task. As of today, the required pre-processing of data sources is a very cumbersome and time-consuming task. In a conventional data analytics application, the pre-processing of the data sources is mostly done manually by experts or based on special software algorithms that implement the transformations explicitly. In addition, the mapping of data sets is documented in non-standardized data formats being developed for just this one envisioned data analytics application. Therefore, the conventional established routines of realizing data analytics applications in the industrial production domain hinder the efficient reuse of pre-processed data sources as well as hinder the seamless integration of pre-processed data sources within another and possibly more complex scenario.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a method and a system for providing data analytics results for a process performed in an industrial plant to enable a seamless integration and reuse of pre-processed data analytics results within other and possibly more complex data analytics tasks are provided.

According to a first aspect, the method provides a method for providing data analytics results for a process performed in an industrial plant. The method includes providing semantic knowledge models stored in a knowledge model repository. The semantic knowledge models include at least one semantic plant model of an industrial plant that describes semantically a configuration of the respective industrial plant and storage locations of process data provided by data sources of the industrial plant when performing at least one process therein. The semantic knowledge models also include at least one semantic process model of a process that describes semantically the respective production and transformation process steps performed within an industrial plant. The method also includes selecting at least one analytics application that describes semantically at least one process step and at least one parameter required for accomplishing an analytics task. The method includes processing the selected analytics application and selected instantiated semantic knowledge models to infer at least one storage location of at least one data source of the industrial plant, and executing the selected data analytics application by an execution engine using accessed process data provided by the inferred data sources of the industrial plant to generate the data analytics results.

In a possible embodiment of the method according to the first aspect, the semantic knowledge models are instantiated for a particular industrial plant and/or a process performed therein.

In a still further possible embodiment of the method according to the first aspect, the data analytics results are stored in a data analytics results repository and/or are returned to a requesting analytics application.

In a still further possible embodiment of the method according to the first aspect, the semantic process model includes a set of possible process steps with each including a generic transformation model describing a set of possible production process steps with each including a generic transformation model describing a set of possible transformation process steps. The semantic process model also includes a plant-specific transformation path model describing a set of transformation paths with a sequence of transformation process steps that may be executed by a particular industrial plant. Each instance of a plant-specific transformation path model provides a set of measurement process data of product instances produced by the respective process step.

In a further possible embodiment of the method according to the first aspect, the semantic plant model includes a plant structure model capturing information regarding the structure, components, and interfaces of the industrial plant, a plant measurement model capturing process data regarding measurements of process steps performed within the industrial plant, and a plant data storage model indicating storage locations and/or data formats of process data provided by processes performed within the industrial plant.

In a further possible embodiment of the method according to the first aspect, the semantic plant model further includes a product model indicating product data of intermediate and/or final products produced by process steps of processes performed within an industrial plant.

In a possible embodiment of the method according to the first aspect, the semantic plant model further includes an order model indicating order data related to ordered intermediate and/or final products produced by process steps of processes performed within an industrial plant.

In a still further possible embodiment of the method according to the first aspect, the accessed process data provided by the inferred data sources of the industrial plant are pre-processed before executing the data analytics application.

One or more of the present embodiments further provide, according to a second aspect, a system for providing data analytics results for a process performed in an industrial plant.

According to the second aspect, a system for providing data analytics results for a process performed in an industrial plant includes a knowledge model repository configured to store semantic knowledge models. The semantic knowledge models include at least one semantic plant model of an industrial plant that describes semantically a configuration of the respective industrial plant and storage locations of process data provided by data sources of the industrial plant when performing at least one process therein. The semantic knowledge models also include at least one semantic process model of a process that describes semantically the respective process steps of the process performed within an industrial plant. The system includes a selection unit adapted to select at least one analytics application that describes semantically at least one process step and at least one parameter required for accomplishing the analytics task, and a processing unit adapted to process the selected analytics application and selected instantiated semantic knowledge models to infer at least one storage location of at least one data source of the industrial plant. The system also includes an execution engine adapted to execute the selected data analytics application using accessed process data provided by the inferred data sources of the industrial plant to generate the data analytics results.

In a still further possible embodiment of the system according to the second aspect, the data analytics results are stored in a data analytics results repository of the system and/or are returned to a requesting analytics application.

In a still further possible embodiment of the system according to the second aspect, the semantic process model includes a set of possible production process steps with each including a generic transformation model describing a set of possible transformation process steps, and a plant-specific transformation path model describing the set of transformation paths with a sequence of transformation process steps that may be executed by a particular industrial plant.

In a further possible embodiment of the system according to the second aspect, the semantic plant model includes a plant structure model capturing information regarding the structure, components, and interfaces of the industrial plant. The semantic plant model also includes a plant measurement model capturing process data regarding measurements of process steps of a process performed within the industrial plant, and a plant data storage model indicating storage locations and/or data formats of process data.

In a possible embodiment of the system according to the second aspect, the semantic plant model further includes a product model indicating production data of intermediate and/or final products produced by process steps of a process performed within an industrial plant, and an order model indicating order data related to ordered intermediate and/or final products produced by process steps of a process performed within an industrial plant.

One or more of the present embodiments further provide, according to a third aspect, an industrial plant.

According to the third aspect, the industrial plant includes a central or distributed control unit configured to generate control signals depending on data analytics results provided by a method for providing data analytics results according to the first aspect for a process performed in the industrial plant. The generated control signals control process steps of processes performed by components of the industrial plant.

In a possible embodiment of the industrial plant according to the third aspect, the industrial plant is a steel plant adapted to produce steel products.

### BRIEF DESCRIPTION OF THE DRAWINGS

FIG. 1 shows a block diagram of an exemplary embodiment of a system for providing data analytics results;

FIG. 2 shows a flowchart of an exemplary embodiment of a method for providing data analytics results for a process performed in an industrial plant;

FIG. 3 shows a schematic diagram for illustrating a product history of a product manufactured in an industrial steel plant for illustrating a use case of the method and system according to an embodiment;

FIG. 4 shows a schematic diagram of a data mapping that may be performed in an industrial steel plant.

### DETAILED DESCRIPTION

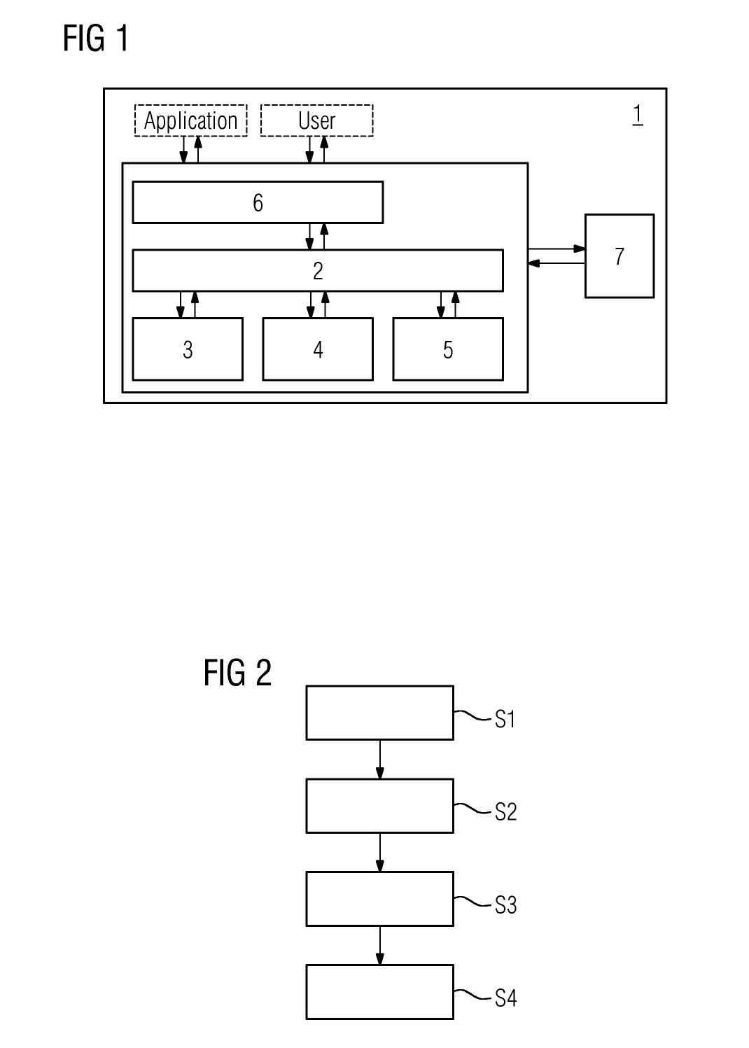

FIG. 1 shows an exemplary embodiment of a system 1 for providing data analytics results for a process performed in an industrial plant.

The system 1 includes a knowledge model repository 2, as illustrated in FIG. 1. The knowledge model repository 2 is configured to store semantic knowledge models. The knowledge models stored in the knowledge model repository 2 of the system 1 include at least one semantic plant model of an industrial plant such as a steel plant and at least one semantic process model of a process performed within the industrial plant. The semantic plant model of the industrial plant describes semantically a configuration of the respective industrial plant and storage locations of process data provided by data sources of the industrial plant when performing at least one process therein. The semantic plant model describes the structural aspects of the industrial plant and includes information about measurements and storage locations on a high-level semantic (e.g., schema-level). Further, the industrial plant model encompasses any relations that map the high-level concepts onto concrete objects/items in the physical plant installation of the industrial plant (e.g., semantic annotation). In a possible embodiment, the industrial plant model is initially instantiated, where a generation of semantic annotation is accomplished.

The knowledge model repository 2 of the system 1 further includes at least one semantic process model of a process that describes semantically the respective process steps of the process performed within the respective industrial plant. The semantic process model describes semantically a sequence of a production process on a generic level. Further, the semantic process model covers the plant-specific realization of the production processes. Each implementation of a production process may include several product states that again are characterized by a sequence of transformations that are to be accomplished in order to attain the subsequent product state.

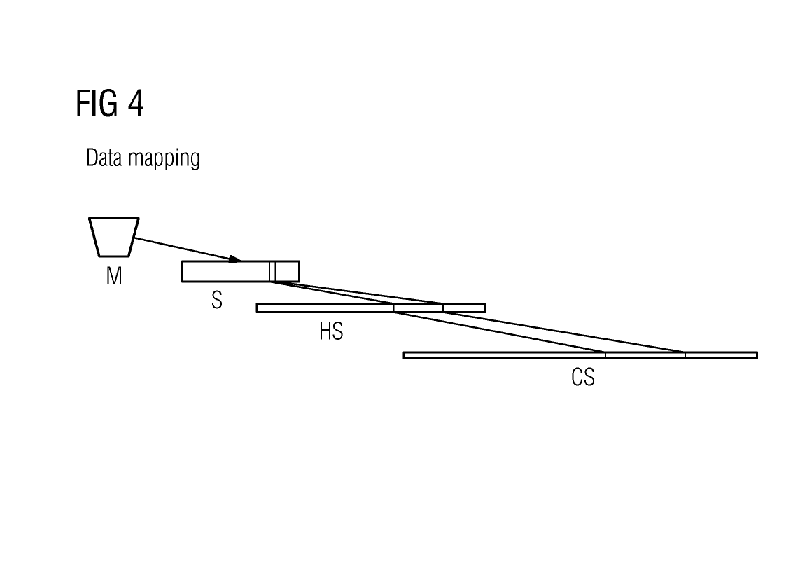

For example, in a steel production domain or steel plant, the high-level process steps may include four high-level states (e.g., melt M, slab S, hot strip HS, and cold strip CS), as also illustrated in the data mapping schematic diagram of FIG. 4. In the manufacturing process chain of an industrial steel plant, possible intermediate products sum as scrap are heated in a furnace to provide melt as a further intermediate product. From the melt M, a slab S is produced in a continuous caster. From the slab S, a hot strip HS is produced in a hot strip mill of the steel plant. In a cold strip mill, a cold strip CS is derived from the hot strip HS. The process chain that performs the process steps includes different components such as a furnace, a ladle, a continuous caster, a hot strip mill and a cold strip mill. At each stage of the production chain, different operations are performed. At an electrical furnace of the industrial steel plant, scrap is added into an electrical furnace. Accordingly, at this operation stage, operations such as scrap addition, power-on, and/or power-off are performed. For each stage, process data is provided. For example, at the electrical furnace of the steel plant, process data such as scrap composition, energy consumption, or off-gas composition is provided. At the stage of the next intermediate product melt M, operations include, for example, reheating, cooling, alloying, and/or flushing. The corresponding process data includes, for example, alloying elements or temperature. At the stage of the intermediate product slab, operations or process steps include, for example, grinding, welding, turning, cutting and storing. Corresponding process data includes, for example, casting temperature, casting progress, used casting powder, or bath level. At the stage of the intermediate product hot strip HS, the performed process steps or operations include, for example, temperature treatment, turning, and cutting. The corresponding process data includes, for example, temperature profile, thickness profile, width profile, or rolling pressure. At the stage of the intermediate product cold strip CS, the operations or process steps include temperature treatment, turning, and cutting performed at the cold strip mill. Corresponding process data includes, for example, temperature profile, thickness profile, width profile, and rolling pressure.

The semantic process model stored in the knowledge model repository 2 of the system 1 includes a set of possible production process steps with each including a generic transformation model describing a set of possible transformation process steps. The semantic process model further includes a plant-specific transformation path model describing the set of transformation paths with a sequence of transformation process steps that may be executed by a particular industrial plant such as a steel plant. Each instance of a plant-specific transformation path model provides a set of measurement process data of product instances produced by the respective process step. The generic transformation model describes a set of all transformations or process steps (e.g., a plant-independent space of all possibilities). The plant-specific transformation path model describes a set of all transformation paths that may be executed at a particular industrial plant (e.g., a plant-specific space of possibilities). Thus, each of the described transformation paths represents a sequence of transformations that are compliant to the underlying design of the specific industrial plant as well as accounts for any dependencies and interrelations between the transformations. Each transformation may be characterized by a set of measurements of the product instances that are produced in this particular transformation.

The semantic plant model also stored in the knowledge model repository 2 of the system 1 may include in a possible embodiment a plant structure model, a plant measurement model, and/or a plant data storage model. The plant structure model includes information or data regarding the structure, components, and interfaces of the industrial plant. The plant structure model captures information on structural aspects of the industrial plant by describing the hardware components, roles, and interfaces. In a possible embodiment, one may identify different roles of domain experts in the manufacturing domain. For example, three different expert roles may include knowledge engineers, suppliers, and plant engineers.

The plant measurement model includes process data regarding measurements of process steps performed within the industrial plant. For example, the measurement model may capture information regarding relevant measurements of a steel production process by describing measurements, roles, and locations.

The plant data storage model indicates storage locations and/or data formats of process data provided by processes performed within the industrial plant. The plant data storage model describes how measurements are stored and how the data may be accessed. In a possible embodiment, the semantic plant model may further include a product model and/or an order model. The product model indicates product data of intermediate and/or final products produced by process steps of processes performed within the industrial plant. Accordingly, the product model describes product-related information. The product model may, for example, describe the product-related information by listing relevant attributes captured within the life cycle of the respective product.

The order model indicates order data related to ordered intermediate and/or final products produced by the process steps of processes performed within the industrial plant. The order model may describe how technical and other order information is handled and where this information is stored.

As shown in FIG. 1, the knowledge model repository 2 of the system 1 may exchange data with other databases or repositories. In the embodiment shown in FIG. 1, the knowledge model repository 2 may exchange data with a plant data repository 3, a data analytics repository 4, and a data analytics result repository 5. The plant data repository 3 may include all data sources produced and stored in the context of the respective production process. For example, the plant data repository 3 may collect any historical information or data about the accomplished production processes (e.g., all accomplished transformations). The data sources may be distributed along the process production chain.

The data analytics algorithm repository 4 may store a set of data analytics applications that may be stored together with corresponding semantic description(s) in a dedicated data analytics algorithm storage location.

Further, the data analytics result repository 5 forms the dedicated storage location for storing all accomplished data analytics results with corresponding dedicated semantic description(s) specifying how the data analytics results have been generated (e.g., input data source and data analytics algorithm).

In a possible embodiment, the knowledge model repository 2 may include an analytics results model that may be used to describe the analytics results by providing standardized labels for input data sources, specified measurements and parameter, type of analytics application, and the corresponding storage location.

The system 1 further includes in the illustrated embodiment an analytics composer 6 that includes a processing unit. The analytics composer 6 may access for a given instantiated scenario model description the corresponding required input data sources from the plant data repository 3 as well as the needed analytics application from the data analytics algorithm storage location in the data analytics algorithm repository 4. A selection unit is adapted to select at least one analytics application that describes semantically at least one process step and at least one parameter required for accomplishing an analytics task. The processing unit of the analytics composer 6 is adapted to process the selected analytics application and the selected instantiated semantic knowledge models to infer at least one storage location of at least one data source of the industrial plant.

The system 1, as illustrated in FIG. 1, further includes an execution engine 7. The execution engine 7 is adapted to execute the selected data analytics application using accessed process data provided by the inferred data sources of the industrial plant to generate the data analytics results. The execution engine 7 runs the selected as well as customized (e.g., by specifying the parameter values) data analytics algorithms on the selected or specified input data sources to generate the expected analytics results. Besides generating the analytics results, the execution engine 7 may compile a protocol that describes the input data and analytics application on a semantic level.

FIG. 2 shows a flowchart of an exemplary embodiment of a method for providing data analytics results for a process performed in an industrial plant such as an industrial steel plant. In act S1, semantic knowledge models are provided in a knowledge model repository such as the knowledge model repository 2 illustrated in FIG. 1. The semantic knowledge models include at least one semantic plant model of the industrial plant and at least one semantic process model of a process that describes semantically the respective production and transformation process steps performed within the industrial plant. The semantic plant model of the industrial plant describes semantically a configuration of the respective industrial plant as well as storage locations of process data provided by data sources of the industrial plant when performing at least one process therein. In a possible embodiment, all relevant data sources of the plant data repository 3 are semantically annotated with semantic labels of the knowledge models. For example, the semantic plant model may be initialized with the dedicated references aligning the high-level description of the plant knowledge model with the concrete storage location of the measurements generated during the production process and stored in the plant data repository 3. These annotations may be determined automatically as well as by human interaction.

The semantic process model may also be initialized. According to the structure or design of the industrial plant and the respective transactions, the process model may be initialized. A data analytics result model may be informed about the type of data sources available in the industrial plant as well as about the type of scenarios that may be requested within the particular industrial plant in order to be able to compile semantic description for the data analytics results.

In act S2, at least one analytics application that describes semantically at least one process step and at least one parameter for accomplishing an analytics task is selected. The selection may be accomplished in different ways. In a possible embodiment, an external application performs the selection according to a particular state of the applications. In an alternative embodiment, a user selects the analytics application manually according to the working task to be accomplished.

In act S3, the selected analytics application and selected instantiated semantic knowledge models are processed by a processing unit (e.g., by a processing unit of the analytics composer 6) to infer at least one storage location of at least one data source of the industrial plant. By aligning and processing the data analytics model and the industrial plant model, the processing unit of the analytics composer 6 is able to infer which data sources and/or data entries are used for the data analytics tasks to be accomplished. Further, the processing unit of the analytics composer 6 may find out how to physically access the required data sources and/or data entries. The industrial plant model describes on a high-level manner where the needed data sources are stored. Further, the instantiating of the industrial plant model informs the processing unit at which location (e.g., in which database) the needed data item may be accessed for the particular industrial plant. The processing unit accesses the needed input data sources and sends the corresponding information to the execution engine 7.

In act S4, the selected data analytics applications are executed by the execution engine 7 using accessed process data provided by the inferred data sources of the industrial plant to generate the data analytics results. The information specified in the data analytics model informs the processing unit which data analytics applications are to be accessed as well as how to prepare those applications by specifying parameters. The processing unit of the analytics composer 6 sends the customized data analytics application to the execution engine 7. The execution engine 7 then starts the selected data analytics application with the provided input data sources.

The data analytics results generated by the execution engine 7 may be used in different ways. The data analytics results may be returned to the requesting application. Further, the data analytics results may be stored within the data analytics results repository 5. This provides that the analytics results may be reused. Thus, the data analytics results get enhanced by a corresponding semantic description encompassing information of a corresponding triggering data analytics model.

The method and system according to one or more of the present embodiments rely on semantic description in order to establish a basis for the seamless reuse of pre-processed data sources within other data analytics challenges or tasks. The method and system according to one or more of the present embodiments use a semantic model on various levels. This includes a semantic model covering a generic set of analytics tasks (e.g., data analytics applications that may be accomplished within the production process).

The method and system according to one or more of the present embodiments provide semantic models on various levels in order to enable the seamless integration and reuse of pre-processed data analytics results with other possibly more complex data analytics tasks. This is accomplished by defining, initiating, and aligning of semantic models on various levels. The method and system rely on a semantic description of an industrial plant model that semantically describes how to access the data provided by the respective industrial plant. Further, the method and system rely on a semantic description of a process model that semantically describes the high-level production process as well as the concrete production process implementation within the industrial plant. Further, the method and system according to one or more of the present embodiments rely on a semantic description of the data analytics model that semantically describes the analytics task envisioned and what type of data sources and type of algorithm are used to accomplish the respective task.

By aligning the different knowledge models, data from various domains may be integrated, and pre-processed data sources may be reused within other contexts.

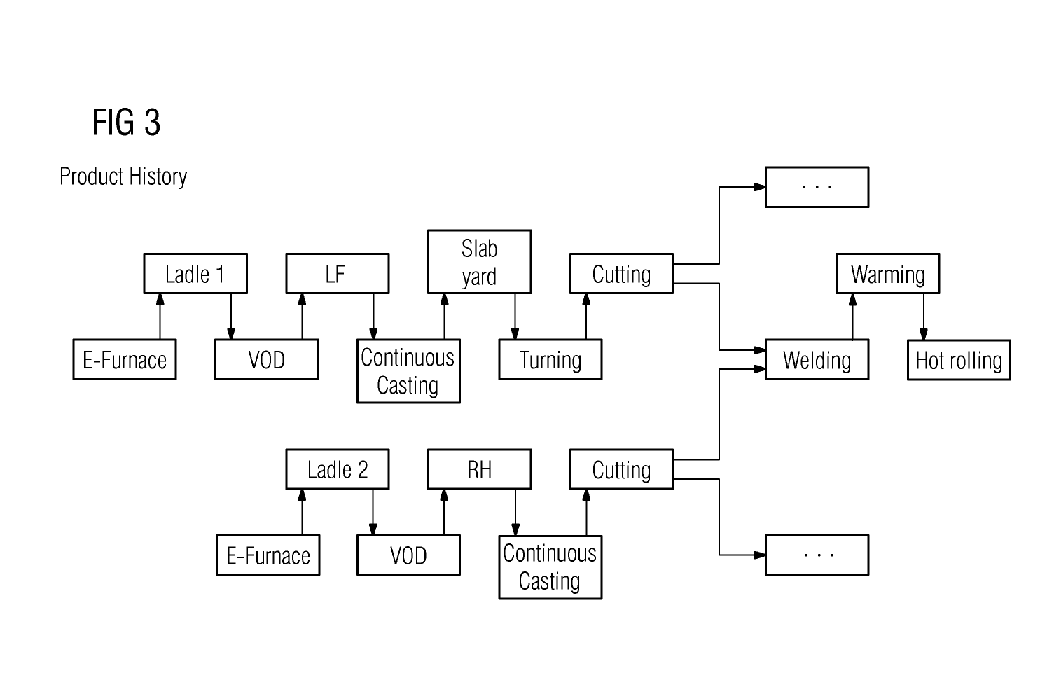

The method and system according to one or more of the present embodiments may be used for any industrial plant including components for performing an industrial production process. The industrial plant may include a central or distributed control unit that is configured to generate control signals depending on the data analytics results provided by the method according to one or more of the present embodiments, as illustrated, for example, in FIG. 2. The generated control signals may control process steps of processes performed by components of the industrial plant. The industrial plant is, for example, a steel plant adapted to produce steel products, as illustrated schematically in FIGS. 3, 4. The use of semantic modelling allows managing of vast amounts of different kinds of information and data and knowledge in a very precise and standardized way. The semantic model provides a vocabulary for defining the structure of the industrial plant, the underlying processes, and intermediate or final products in a formal manner. For each industrial plant, a dedicated instantiating of the structure and process model describes a specific plant configuration.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for providing data analytics results for a process performed in an industrial plant, the method comprising:
providing semantic knowledge models stored in a knowledge model repository, the semantic knowledge models comprising:
at least one semantic plant model of an industrial plant, the at least one semantic plant model describing semantically a configuration of the respective industrial plant and storage locations of process data provided by data sources of the industrial plant when performing at least one process therein; and
at least one semantic process model of a process, the at lest one semantic process model describing semantically respective production and transformation process steps performed within an industrial plant;
selecting at least one analytics application that describes semantically at least one process step and at least one parameter required for accomplishing an analytics task;
inferring at least one storage location of at least one data source of the industrial plant, the inferring comprising processing, by a processor, the at least one selected analytics application and selected instantiated semantic knowledge models; and
executing, by an execution engine, the at least one selected analytics application using accessed process data provided by the inferred data sources of the industrial plant to generate the data analytics results.

2. The method of claim 1, wherein semantic knowledge models are instantiated for a particular industrial plant, a process performed in the particular industrial plant, or the particular industrial plant and the process performed in the particular industrial plant.

3. The method of claim 1, further comprising storing the data analytics results in a data analytics results repository, returning the data analytics results to a requesting analytics application, or a combination thereof.

4. The method of claim 1, wherein the semantic process model comprises a set of possible production process steps with each comprising:
a generic transformation model describing a set of possible transformation process steps; and
a plant-specific transformation path model describing a set of transformation paths with a sequence of transformation process steps that are executable by a particular industrial plant,
wherein each instance of a plant-specific transformation path model provides a set of measurement process data of product instances produced by the respective process step.

5. The method of claim 1, wherein the at least one semantic plant model comprises:
a plant structure model capturing information regarding a structure, components and interfaces of the industrial plant;
a plant measurement model capturing process data regarding measurements of process steps performed within the industrial plant; and
a plant data storage model indicating storage locations, data formats, or storage locations and data formats of process data provided by processes performed within the industrial plant.

6. The method of claim 5, wherein the semantic plant model further comprises a product model indicating product data of intermediate, final, or intermediate and final products produced by process steps of processes performed within the industrial plant.

7. The method of claim 5, wherein the at least one semantic plant model further comprises an order model indicating order data related to ordered intermediate, final, or intermediate and final products produced by process steps of processes performed within the industrial plant.

8. The method of claim 1, wherein the accessed process data provided by the inferred data sources of the industrial plant are pre-processed before executing the data analytics application.

9. A system for providing data analytics results for a process performed in an industrial plant, the system comprising:
a knowledge model repository configured to store semantic knowledge models, the semantic knowledge models comprising:
at least one semantic plant model of an industrial plant, the at least one semantic plant model describing semantically a configuration of the respective industrial plant and storage locations of process data provided by data sources of the industrial plant when performing at least one process therein; and
at least one semantic process model of a process, the at least one semantic process model describing semantically the respective process steps of the process performed within an industrial plant;
a selection unit configured to select at least one analytics application that describes semantically at least one process step and at least one parameter required for accomplishing an analytics task;
a processor configured to process the selected analytics application and selected instantiated semantic knowledge models to infer at least one storage location of at least one data source of the industrial plant; and
an execution engine configured to execute the selected data analytics application using accessed process data provided by the inferred data sources of the industrial plant to generate the data analytics results.

10. The system of claim 9, wherein the data analytics results are stored in a data analytics results repository of the system, are returned to a requesting analytics application, or a combination thereof.

11. The system of claim 9, wherein the semantic process model comprises:
a set of possible production process steps with each comprising a generic transformation model describing a set of possible transformation process steps; and
a plant-specific transformation path model describing a set of transformation paths with a sequence of transformation process steps that are executable by a particular industrial plant.

12. The system of claim 9, wherein the at least one semantic plant model comprises:
a plant structure model capturing information regarding a structure, components and interfaces of the industrial plant;
a plant measurement model capturing process data regarding measurements of process steps of a process performed within the industrial plant; and
a plant data storage model indicating storage locations, data formats, or storage locations and data formats of process data.

13. The system of claim 12, wherein the at least one semantic plant model further comprises:
a product model indicating product data of intermediate, final, or intermediate and final products produced by process steps of a process performed within the industrial plant; and
an order model indicating order data related to ordered intermediate, final, or intermediate and final products produced by process steps of a process performed within the industrial plant.

14. An industrial plant comprising:
a central or distributed control unit configured to generate control signals depending on data analytics results, provision of the data analytics results comprising:
provision of semantic knowledge models stored in a knowledge model repository, the semantic knowledge models comprising:
at least one semantic plant model of an industrial plant, the at least one semantic plant model describing semantically a configuration of the respective industrial plant and storage locations of process data provided by data sources of the industrial plant when performing at least one process therein;
at least one semantic process model of a process, the at lest one semantic process model describing semantically respective production and transformation process steps performed within an industrial plant;
selection of at least one analytics application that describes semantically at least one process step and at least one parameter required for accomplishing an analytics task;
process of the at least one selected analytics application and selected instantiated semantic knowledge models to infer at least one storage location of at least one data source of the industrial plant;
execution, by an execution engine, of the at least one selected analytics application using accessed process data provided by the inferred data sources of the industrial plant to generate the data analytics results,
wherein the generated control signals control process steps of processes performed by components of the industrial plant.

15. The industrial plant of claim 14, wherein the industrial plant is a steel plant adapted to produce steel products.
